(19) United States
(12) Patent Application Publication
(10) Pub. No.: US 2025/0079460 A1
(43) Pub. Date: Mar. 6, 2025

(54) CATHODE ACTIVE MATERIAL FOR LITHIUM SECONDARY BATTERY AND LITHIUM SECONDARY BATTERY INCLUDING THE SAME

(71) Applicant: SK ON CO., LTD., Seoul (KR)

(72) Inventors: Mi Jung NOH, Daejeon (KR); Byoung Ki SON, Daejeon (KR); Jae Ho CHOI, Daejeon (KR); Kook Hyun HAN, Daejeon (KR); Eun Jin KIM, Daejeon (KR); Yong Seok LEE, Daejeon (KR)

(21) Appl. No.: 18/812,949

(22) Filed: Aug. 22, 2024

(30) Foreign Application Priority Data
Sep. 4, 2023 (KR) 10-2023-0116925

(51) Int. Cl. H01M 4/525; H01M 4/02; H01M 4/131; H01M 4/133; H01M 4/134; H01M 4/38; H01M 4/505; H01M 4/583; H01M 10/0525

(52) U.S. Cl. CPC H01M 4/525; H01M 4/131; H01M 4/133; H01M 4/134; H01M 4/386; H01M 4/505; H01M 4/583; H01M 10/0525; H01M 2004/027; H01M 2004/028

(57) ABSTRACT

A cathode active material for a lithium secondary battery includes a lithium-transition metal oxide including nickel (Ni), cobalt (Co), manganese (Mn), strontium (Sr) and sulfur (S). A mole fraction of nickel based on the total number of moles of nickel, cobalt and manganese in the lithium-transition metal oxide is 0.9 or more. A molar ratio of cobalt relative to manganese in the lithium-transition metal oxide is in a range from 0.9 to 1.5. A molar ratio of strontium (Sr) relative to sulfur (S) in the lithium-transition metal oxide is greater than 0, and 4 or less.

### CROSS-REFERENCE TO RELATED APPLICATION AND CLAIM OF PRIORITY

This application claims priority to Korean Patent Application No. 10-2023-0116925 filed on Sep. 4, 2023 in the Korean Intellectual Property Office (KIPO), the entire disclosure of which is incorporated by reference herein.

### TECHNICAL FIELD

The disclosure of this patent application relates to a cathode active material for a lithium secondary battery and a lithium secondary battery including the same. More particularly, the disclosure of this patent application relates to a cathode active material for a lithium secondary battery including cobalt and manganese and a lithium secondary battery including the same.

### BACKGROUND

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as an eco-friendly power source of an electric automobile, etc.

Examples of the secondary battery include a lithium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

An NCM-based active material containing nickel, cobalt and manganese is used as a cathode active material for a lithium secondary battery. As an application range of the lithium secondary battery is extended to a large-scaled device such as the electric vehicle, a high-Ni-based lithium oxide having an increased nickel content is being developed as a cathode active material for achieving a high capacity of the lithium secondary battery. However, as a content of nickel in the cathode active material increases, stability of a chemical structure and a crystal structure of an active material particle may be degraded.

For example, a cation mixing phenomenon in which a nickel cation is transferred to a lithium site may occur, thereby degrading stability and life-span properties during repeated charging/discharging operation of the lithium secondary battery.

Additionally, as the nickel content increases, contents of cobalt and manganese contained in the cathode active material may relatively decrease. A construction of a cathode active material capable of providing sufficient conductivity and stability while obtaining economic feasibility in a production of the cathode active material is required.

### SUMMARY

According to an aspect of the present disclosure, there is provided a cathode active material for a lithium secondary battery having improved stability and charging/discharging properties.

According to an aspect of the present disclosure, there is provided a lithium secondary battery including the cathode active material.

A cathode active material for a lithium secondary battery includes a lithium-transition metal oxide including nickel (Ni), cobalt (Co), manganese (Mn), strontium (Sr) and sulfur (S). A mole fraction of nickel based on the total number of moles of nickel, cobalt and manganese in the lithium-transition metal oxide is 0.9 or more. A molar ratio of cobalt relative to manganese in the lithium-transition metal oxide is in a range from 0.9 to 1.5. A molar ratio of strontium (Sr) relative to sulfur (S) in the lithium-transition metal oxide is greater than 0, and 4 or less.

In some embodiments, the molar ratio of cobalt relative to manganese in the lithium-transition metal oxide may be in a range from 1 to 1.5.

In some embodiments, the molar ratio of strontium (Sr) to sulfur (S) in the lithium-transition metal oxide may be 0.1 to 3.

In some embodiments, a content of nickel in elements other than lithium and oxygen in the lithium-transition metal oxide may be 90 wt % or more.

In some embodiments, the lithium-transition metal oxide may further include Al.

In some embodiments, a content of Al based on a total weight of the lithium-transition metal oxide may be in a range from 1,000 ppm to 10,000 ppm.

In some embodiments, the lithium-transition metal oxide may include a layered structure or a crystal structure represented by Chemical Formula 1.

LiₐSr_{b}(NiₓM1₁₋ₓ)M2_{y}O_{2-z}S_{z} [Chemical Formula 1]

in Chemical Formula 1, 0.95≤a+b≤1.1, 0<b≤0.1, 0.9≤x<1.0, 0≤y≤0.1, and 0<z≤0.1. M1 may include Co and Mn, and M2 may include a heterometal excluding Ni, Co, Mn and Sr.

In some embodiments, in Chemical Formula 1, M2 may include at least one selected from Al, Rb, Y, Zr, Nb, Mo, Ru, Ag, Sn and Sb.

A lithium secondary battery includes a cathode including the above-described cathode active material for a lithium secondary battery, and an anode facing the cathode and including an anode active material that includes a carbon-based active material and a silicon-based active material.

In some embodiments, a weight ratio of a silicon element based on a total weight of a carbon element (C) and the silicon element (Si) included in the anode active material may be in a range from 1% to 10%.

In some embodiments, a weight ratio of a silicon element based on a total weight of a carbon element (C) and the silicon element (Si) included in the anode active material may be in a range from 1% to 7%.

In some embodiments, the carbon-based active material may include natural graphite or artificial graphite.

In a cathode active material for a lithium secondary battery according to embodiments of the present disclosure, strontium (Sr) and sulfur (S) may be doped or bonded to a chemical structure or a crystal structure of a lithium-transition metal oxide.

A sulfur atom may be substituted or doped at an oxygen (O) site in the chemical structure or the crystal structure of the lithium-transition metal oxide. Accordingly, release of oxygen and generation of an oxygen gas caused during repeated charging/discharging of the secondary battery may be suppressed.

Sr has a +2 ion state, and a Sr ion may have larger ion radii than that of a lithium ion and a nickel ion. Accordingly, Sr effectively suppresses a cation mixing of nickel ions and may promote doping of S.

The lithium-transition metal oxide contain cobalt and manganese, and a molar fraction of nickel may be 80% or more. The molar fractions of cobalt and manganese in the lithium-transition metal oxide may be maintained in a predetermined range, thereby achieving conductivity and stability of the cathode active material.

In example embodiments, the lithium secondary battery may include the cathode active material and a silicon-based anode active material. A content of silicon in the silicon-based anode active material may be maintained in a predetermined range, so that discharge capacity/power and high-temperature stability may also be balanced in the anode.

The lithium secondary battery of the present disclosure may be widely applied in green technology fields such as an electric vehicle, a battery charging station, a solar power generation, a wind power generation, etc., using a battery, etc. The lithium secondary battery according to the present disclosure may be used for eco-friendly electric vehicles and hybrid vehicles to prevent a climate change by suppressing air pollution and greenhouse gas emissions, etc.

### BRIEF DESCRIPTION OF THE DRAWINGS

FIGS. 1 and 2 are a schematic plan view and a cross-sectional view, respectively, illustrating a lithium secondary battery in accordance with example embodiments.

FIG. 3 is a DSC (differential scanning calorimetry) analysis graph of cathode active material particles of Examples 1 and 2 and Comparative Example 1.

### DETAILED DESCRIPTION OF THE EMBODIMENTS

Embodiments of the present disclosure provide a cathode active material for a lithium secondary battery containing nickel, cobalt and manganese and having a doping element. Embodiments of the present disclosure provide a lithium secondary battery including the cathode active material and having improved capacity, efficiency and stability.

Embodiments of the present disclosure will be described in more detail. However, the drawings and embodiments attached to the present specification are intended to enhance understanding the technical idea of the present disclosure, and the concepts of the present invention are not to be construed as being limited to those described in such drawings and embodiments.

### <Cathode Active Material for Lithium Secondary Battery>

A cathode active material for a lithium secondary battery (hereinafter, may be abbreviated as “a cathode active material”) includes a lithium-transition metal oxide. The cathode active material for a lithium secondary battery may include a plurality of lithium-transition metal oxide particles.

For example, a content of the lithium-transition metal oxide particles may be 50 wt % or more, 70 wt % or more, 80 wt % or more, 90 wt % or more, or 95 wt % based on a total weight of the cathode active material.

In an embodiment, the cathode active material may further include an NCM-based active material, a Co-less-based active material, an over-lithiated oxide (OLO)-based active material, a lithium iron phosphate-based active material, etc., in addition to the lithium-transition metal oxide particle as will be described in more detail below.

In an embodiment, the cathode active material may substantially consist of the lithium-transition metal oxide particles.

The lithium-transition metal oxide may contain nickel (Ni), cobalt (Co) and manganese (Mn). Co and Mn may serve as main active elements of the cathode active material together with Ni.

According to embodiments of the present disclosure, a mole fraction of nickel of elements excluding lithium and oxygen included in the lithium-transition metal oxide may be 0.8 or more. For example, the mole fraction of nickel relative to total moles of nickel, cobalt and manganese included in the lithium-transition metal oxide may be 0.8 or more.

In some embodiments, the mole fraction of nickel may be 0.85 or more, 0.88 or more, 0.9 or more, 0.91 or more, 0.92 or more, 0.945 or more, or 0.95 or more.

In an embodiment, the molar fraction of nickel may be adjusted to 0.9 or more to achieve high capacity.

In some embodiments, a content of nickel based on elements excluding lithium and oxygen included in the lithium-transition metal oxide may be 90 wt % or more.

According to embodiments of this disclosure, a molar ratio of cobalt to manganese contained in the lithium-transition metal oxide (hereinafter, that may be expressed as Co/Mn) may be in a range from 0.9 to 1.5.

For example, when Co/Mn is less than 0.9, a conductivity of the cathode active material may be excessively reduced. Accordingly, a power of the secondary battery may be reduced, a layered structure may be collapsed, and thermal stability may be lowered due to a reduction in Co.

When Co/Mn exceeds 1.5, a content of relatively high-cost Co may be increased to deteriorate an overall economic feasibility of the secondary battery. Further, a content of Mn may not be sufficient to cause instability due to the introduction of a high-Ni composition.

In an embodiment, Co/Mn may be in a range from 1 to 1.5. In an embodiment, Co/Mn may exceed 1, and may be less than or equal to 1.5. In an embodiment, Co/Mn may be greater than 1 and less than 1.5. In the above range, collapse of the layered structure collapse of the lithium-transition metal oxide may be effectively prevented, and cracks of active material particles may also be prevented.

According to embodiments of the present disclosure, the lithium-transition metal oxide may further contain strontium (Sr) and sulfur (S) in a chemical structure or a crystal structure thereof. For example, strontium (Sr) and sulfur (S) may be present in the form of a dopant in the lithium-transition metal oxide.

In example embodiments, a strontium (Sr) substitution may occur at a lithium site in the chemical structure or the crystal structure of the lithium-transition metal oxide. A sulfur (S) substitution may occur at an oxygen (O) site in the chemical structure or the crystal structure of the lithium-transition metal oxide.

Oxygen sites may be partially replaced by sulfur atoms or sulfur ions, so that deintercalation of oxygen and generation of oxygen gas (O₂) due to side reactions may be suppressed or reduced.

For example, chemical instability on a surface of the cathode active material may be increased by the introduction of the High-Ni composition, and the side reaction with an electrolyte may easily occur. For example, when the cathode active material is exposed to a high-temperature environment, the oxygen gas may be generated by the side reaction, thereby causing battery expansion and explosion.

However, according to embodiments of the present disclosure, the sulfur component may be doped to replace some of the oxygen sites. The sulfur ion have an ion radius larger than that of an oxygen ion, and may improve crystal stability of the lithium-transition metal oxide without easily being released from the crystal structure.

For example, Sr and S may be introduced together from one source, e.g., SrSO₄, in a fabrication of the lithium-transition metal oxide or the cathode active material. A lithium site may be substituted by Sr. Sr has an ion radius larger than that of a lithium ion, so that a boding angle of oxygen-oxygen in the crystal structure may be changed.

Accordingly, when sulfur (S) is substituted or doped, the introduction of sulfur (S) may be promoted while reducing a repulsive force with adjacent oxygen (O). Accordingly, the sulfur doping may be stably implemented without causing excessive damage/deformation of the crystal structure of the lithium-transition metal oxide.

Additionally, Sr has a +2 oxidation number and Li has a +1 oxidation number. Accordingly, Sr may be substituted for two lithium sites, and a repulsive force of S and Li generated during the sulfur doping may also be reduced. Thus, the sulfur doping may be performed more easily.

Strontium (Sr) includes d-orbital, and has an ion radius greater than that of the lithium ion and may has an ion radius greater than that of a nickel ion. Accordingly, a cation mixing caused by a transition of a nickel element or the nickel ion to lithium sites may be avoided or suppressed. For example, strontium (Sr) may serve as a blocking element with respect to the nickel ion transition.

According to embodiments of the present invention, a molar ratio of strontium (Sr) to sulfur (S) in the lithium-transition metal oxide (hereinafter, referred to as Sr/S) may be greater than 0, and less than or equal to 4. When Sr/S is greater than 4, a reduction of a capacity and a power may be caused due to an excessive substitution of Sr, and deformation of the crystal structure/layer structure may be caused. Further, an oxygen gas reduction effect by doping of S may not be substantially implemented.

In some embodiments, Sr/S may be in a range from 0.1 to 3, or 0.2 to 2.5. In the above range, gas generation may be more effectively suppressed while achieving high-temperature life-span properties.

As described above, Co/Mn and Sr/S may be adjusted in the ratios according to embodiments of the present disclosure, so that thermal stability and high-temperature life-span properties of the cathode active material may be improved and a synergistic effects may be induced.

In some embodiments, the cathode active material or the lithium-transition metal oxide may further include an additional doping or a coating element. For example, the doping or coating element may be present on the surface of the lithium-transition metal oxide particle, or may penetrate through the surface of the lithium-transition metal oxide particle to be included in a bonding structure represented by Chemical Formula 1 or Chemical Formula 1-1.

In some embodiments, the lithium-transition metal oxide may have a layered structure or a crystal structure represented by Chemical Formula 1.

LiₐSr_{b}(NiₓM1₁₋ₓ)M2_{y}O_{2-z}S_{z} [Chemical Formula 1]

In Chemical Formula 1, 0.95<a+b≤1.1, 0<b≤0.1, 0.9≤x≤1.0, 0≤y≤0.1, and 0<z≤0.1. M1 may include Co and Mn, and M2 may be a heterogeneous metal excluding Ni, Co, Mn and Sr.

In an embodiment, in Chemical Formula 1, 0<b≤0.05, 0≤y<0.05, and 0<z<0.05.

In an embodiment, in Chemical Formula 1, 0<b≤0.005, 0≤y<0.05, and 0<z<0.005.

As described above, in Chemical Formula 1, 0.9≤Co/Mn≤1.5. M2 may include at least one selected from Al, Rb, Y, Zr, Nb, Mo, Ru, Ag, Sn and Sb. In an embodiment, M2 may include Al.

In some embodiments, the cathode active material or the lithium-transition metal oxide may include Al in a range of 1,000 ppm to 10,000 ppm. When Al is included in the above content range, capacity retention and gas suppression properties may be further enhanced. In an embodiment, a content of Al may be in a range from 1,500 ppm to 8,000 ppm, or from 2,000 ppm to 7,000 ppm based on total weight of the lithium-transition metal oxide.

The chemical structure represented by Chemical Formula 1 represents a bonding relationship included in the layered structure or the crystal structure of the cathode active material, and is not intended to exclude other additional elements. For example, M1 includes Co and/or Mn, and Co and Mn may be provided together with Ni as main active elements of the cathode active material. Chemical Formula 1 is provided to express the bonding relationship of the main active elements and is to be understood as a formula allowing introduction and substitution of the additional elements.

In an embodiment, an auxiliary element for enhancing the chemical stability of the cathode active material or the layered structure/crystal structure may be further included in addition to the main active elements. The auxiliary element may be mixed together in the layered structure/crystal structure to form a bond, and it is to be understood that this case is also included within the range represented by the chemical structure represented by Chemical Formula 1.

The auxiliary element may include Na, Mg, Ca, Ti, Hf, V, Ta, Cr, W, Fe, Cu, Ag, Zn, B, Al, Ga, C, Si, Ba, Ra, P, etc. The auxiliary element may be provided as the above-described additional doping/coating element.

Hereinafter, a method of preparing the cathode active material in accordance with the above-described embodiments of this disclosure is described in more detail.

In example embodiments, an active material metal source may be prepared. The active material metal source may include a nickel source, a manganese source and a cobalt source.

Examples of the nickel source include nickel sulfate (NiSO₄), nickel hydroxide (Ni(OH)₂), nickel nitrate (Ni(NO₃)₂), nickel acetate (Ni(CH₃CO₂)₂), a hydrate thereof, etc. Examples of the manganese source include manganese sulfate (MnSO₄), manganese hydroxide (Mn(OH)₂), manganese nitrate (Mn(NO₃)₂), manganese acetate (Mn(CH₃CO₂)₂), a hydrate thereof, etc. Examples of the cobalt source include cobalt sulfate (CoSO₄), cobalt hydroxide (Co(OH)₂), cobalt nitrate (Co(NO₃)₂), cobalt carbonate (CoCO₃), a hydrate thereof, etc.

Preferably, nickel sulfate, manganese sulfate, and cobalt sulfate may be used as the nickel source, the manganese source and cobalt source, respectively.

In example embodiments, the above-described active material metal sources may be mixed and reacted through, e.g., a coprecipitation method to obtain an active material precursor. For example, the active material precursor may be prepared in the form of a nickel-manganese-cobalt hydroxide.

A precipitating agent and/or a chelating agent may be used to promote the coprecipitation reaction. The precipitating agent may include an alkaline compound such as sodium hydroxide (NaOH), sodium carbonate (Na₂CO₃), etc. The chelating agent may include, e.g., ammonia water, ammonium carbonate, etc.

The active material precursor may be mixed and reacted with a strontium source and a lithium source through a heat treatment. For example, a temperature of the heat treatment may be in a range from about 600° C. to about 850° C.

The strontium source may include, e.g., strontium carbonate (SrCO₃), strontium sulfate (SrSO₄), etc. In an embodiment, strontium sulfate (SrSO₄) may be used. The lithium source may include, e.g., for example, lithium carbonate (Li₂CO₃), lithium nitrate (LiNO₃), lithium acetate (CH₃COOLi), lithium oxide (Li₂O), lithium hydroxide (LiOH), etc. These may be used alone or in a combination of two or more therefrom. In an embodiment, lithium hydroxide may be used as the lithium source.

In some embodiments, a source (e.g., a hydroxide or an oxide) containing the above-described auxiliary element may also be used together.

In some embodiments, impurities such as LiOH and Li₂CO₃ may remain on the surface of the lithium-transition metal oxide particle. The impurities may be removed by washing with an aqueous or organic solvent.

In an embodiment, a post-firing process may be further performed after the washing process. For example, the post-firing process may be performed at a temperature in a range from about 250° C. to 500° C. Doping stability of strontium and sulfur may be improved by the post-firing process.

### <Lithium Secondary Battery>

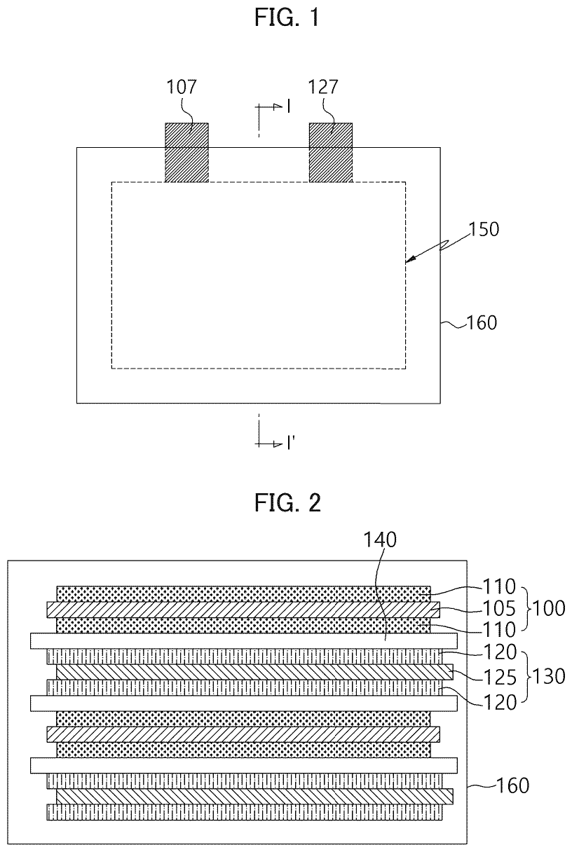

FIGS. 1 and 2 are a schematic plan view and a cross-sectional view, respectively, illustrating a lithium secondary battery in accordance with example embodiments. For example, FIG. 2 is a cross-sectional view taken along line I-I′ of FIG. 1 in a thickness direction.

The structure illustrated in FIGS. 1 and 2 is only an example for convenience of descriptions, and the lithium secondary battery provided by the present disclosure is not limited to the structure of FIGS. 1 and 2.

Referring to FIGS. 1 and 2, a lithium secondary battery may include an electrode assembly including a cathode 100, an anode 130 and a separator 140 interposed between the cathode and the anode. The electrode assembly may be accommodated in a case 160 together with an electrolyte solution to be impregnated therein.

The cathode 100 may include a cathode active material layer 110 formed by coating a cathode active material on a cathode current collector 105. The cathode active material may include a compound capable of reversibly intercalating and de-intercalating lithium ions.

In example examples, the cathode active material may include the above-described lithium-transition metal oxide described. A slurry may be prepared by mixing and stirring the cathode active material above with a binder, a conductive material and/or a dispersive agent in a solvent. The slurry may be coated on the cathode current collector 105, and then dried and pressed to prepare the cathode 100.

The cathode current collector 105 may include, e.g., stainless steel, nickel, aluminum, titanium, copper or an alloy thereof. The cathode current collector 105 may include aluminum or an aluminum alloy.

The binder may include, e.g., an organic binder such as vinylidene fluoride-hexafluoropropylene copolymer (PVDF-co-HFP), polyvinylidene fluoride (PVDF), polyacrylonitrile, polymethylmethacrylate, etc., or an aqueous binder such as styrene-butadiene rubber (SBR) that may be used together with a thickener such as carboxymethyl cellulose (CMC).

For example, a PVDF-based binder may be used as the cathode binder. In this case, an amount of the binder for forming the cathode active material layer 110 may be reduced and an amount of the cathode active material may be relatively increased, and thus the power and the capacity of the secondary battery may be enhanced.

The conductive material may be included to promote an electron transfer between active material particles. For example, the conductive material may include a carbon-based conductive material such as graphite, carbon black, graphene, a carbon nanotube, etc., and/or a metal-based conductive material such as tin, tin oxide, titanium oxide, a perovskite material including LaSrCoO₃, LaSrMnO₃, etc.

The anode 130 may include an anode current collector 125 and an anode active material layer 120 formed on the anode current collector 125. The anode active material layer 120 may include an anode active material.

In example embodiments, the anode active material may include a silicon-based active material. For example, the anode active material may include Si, SiOx (0<x<2), a silicon-carbon composite, a metal-doped silicate or SiOx (0<x<2), etc.

For example, the silicon-based active material above may provide a remarkably increased capacity compared to that of a carbon-based material. However, the silicon-based active material may be excessively expanded in a high-temperature environment or when charging/discharging is repeated, thereby deteriorating battery stability.

Accordingly, the carbon-based active material may be used together with the silicon-based active material as the anode active material. The carbon-based active material may include a crystalline carbon, an amorphous carbon, a carbon composite, a carbon fiber, etc.

For example, the amorphous carbon may include hard carbon, coke, a mesocarbon microbead, a mesophase pitch-based carbon fiber, etc. For example, the crystalline carbon may include natural graphite, artificial graphite, a graphitized coke, a graphitized MCMB, a graphitized MPCF, etc.

In an embodiment, natural graphite and/or artificial graphite may be used as the carbon-based active material.

An amount of the carbon-based active material (e.g., a graphite-based active material) may be greater than an amount of the silicon-based active material based on a total weight of the anode active material to prevent instability due to battery expansion.

In example embodiments, a weight ratio of a silicon element based on a total weight of a carbon element (C) and the silicon element (Si) included in the anode active material may be in a range from 1% to 10%. In the above range, a high capacity/high stability structure may also be provided from the anode together with to the above-described high capacity/high stability design of the cathode.

In some embodiments, the weight ratio of the silicon element in the anode active material may be in a range from 1% to 9%, from 1% to 8%, from 1% to 7%, from 1% to 6%, or from 1% to 5%.

For example, a slurry may be prepared by mixing and stirring the anode active material with a binder, a conductive material, a thickener, etc., in a solvent. The slurry may be coated on the anode current collector 125, and then dried and pressed to prepare the anode 130.

Materials substantially the same as or similar to the above-described materials may be used as the binder and the conductive material for forming the anode. In some embodiments, the binder for forming the anode may include, e.g., an aqueous binder such as styrene-butadiene rubber (SBR) for a compatibility with the carbon-based active material that may be used together with the thickener such as carboxymethyl cellulose (CMC).

In some embodiments, a separator 140 may be interposed between the cathode 100 and the anode 130. The separator 140 may include a porous polymer film formed of a polyolefin-based polymer such as an ethylene homopolymer, a propylene homopolymer, an ethylene/butene copolymer, an ethylene/hexene copolymer, an ethylene/methacrylate copolymer, etc. The separator 140 may include a nonwoven fabric formed of a glass fiber having a high melting point, a polyethylene terephthalate fiber, etc.

In some embodiments, an area (e.g., a contact area with the separator 140) and/or a volume of the anode 130 may be larger than that of the cathode 100. Accordingly, transfer of lithium ions generated from the cathode 100 to the anode 130 may be facilitated without being precipitated.

In example embodiments, an electrode cell may be defined by the cathode 100, the anode 130 and the separator 140, and a plurality of the electrode cells may be stacked to form an electrode assembly 150 having, e.g., a jelly roll shape. For example, the electrode assembly 150 may be formed by winding, stacking, z-folding, stack-folding, etc., of the separator 140.

The electrode assembly may be accommodated together with an electrolyte solution in the case 160 to define the lithium secondary battery. In example embodiments, a non-aqueous electrolyte solution may be used as the electrolyte solution.

The non-aqueous electrolyte solution may include a lithium salt serving as an electrolyte and an organic solvent. The lithium salt may be represented by, e.g., Li⁺X⁻, and examples of an anion X⁻ may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CF₃CO₂⁻, CH₃CO₂⁻, SCN⁻, (CF₃CF₂SO₂)₂N⁻, etc.

For example, the organic solvent may include propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethylsulfoxide, acetonitrile, dimethoxyethane, diethoxyethane, vinylene carbonate, sulfolane, gamma-butyrolactone, propylene sulfite, tetrahydrofuran, etc. These may be used alone or in a combination of two or more therefrom.

As illustrated in FIG. 1, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

The lithium secondary battery may be manufactured in, e.g., a cylindrical shape using a can, a prismatic shape, a pouch shape or a coin shape.

Hereinafter, embodiments of the present disclosure are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### EXAMPLES AND COMPARATIVE EXAMPLES

### (1) Fabrication of Cathode

### Example 1

NiSO₄, CoSO₄ and MnSO₄ were mixed according to the composition of Table 1 using distilled water from which dissolved oxygen was removed by bubbling with N₂ for 24 hours. The solution was added to a reactor of 60° C., and NaOH and NH₃H₂O were used as a precipitating agent and a chelating agent, respectively, to perform a coprecipitation reaction for 48 hours. After the coprecipitation reaction, the product were separated by a centrifuge to remove impurities, and the precipitate was washed about 5 times with distilled water to prepare an active material precursor having an S content adjusted in a range of about 1500 ppm to 3000 ppm.

Sr(OH)₂ as a strontium source and LiOH as a lithium source were further mixed to have the composition of Table 1 below, and fired in a furnace at 710° C. to obtain a cathode active material including lithium-nickel composite metal oxide particles. The S content was adjusted as shown in Table 1.

### Example 2

A precursor was prepared by the same method as that in Example 1, except that except that 1% HCl was introduced into distilled water at a ratio of 100:1, washed about twice, and then further washed about 10 times using distilled water to have an S content of 500 ppm or less.

Thereafter, Sr(OH)₂ as a strontium source, LiOH as a lithium source, (NH₄)₂SO₄ and Al(OH)₃ were further mixed to have the composition of Table 1 below, and fired in a furnace at 710° C. to obtain a cathode active material including lithium-nickel composite metal oxide particles.

### Example 3

A precursor and an active material were prepared by the same method as that in Example 1, except that NiSO₄, CoSO₄, MnSO₄ and Al₂(SO₄)₃ were mixed to have the composition of Table 1 when preparing the precursor.

### Example 4

A precursor and an active material were prepared by the same method as that in Example 1, except that Sr(OH)₂ and Al(OH)₃ were added to have the composition of Table 1 when mixing the lithium source.

### Example 5

A precursor and an active material were prepared by the same method as that in Example 1, except that NiSO₄, CoSO₄, MnSO₄ and Al₂(SO₄)₃ were mixed to have the composition of Table 1, and Sr(OH)₂ and Al(OH)₃ were additionally added when mixing the lithium source.

### Examples 6 and 8

The same process as that in Example 3 was performed except that NiSO₄, CoSO₄ and MnSO₄ were mixed to have the composition of Table 1 in the preparation of the precursor.

### Examples 7 and 9

The same process as that in Example 2 was performed except that NiSO₄, CoSO₄, MnSO₄ and Al₂(SO₄)₃ were mixed to have the composition of Table 1 in the preparation of the precursor.

### Comparative Example 1

The same process as that in Example 3 was performed except that NiSO₄, CoSO₄ and MnSO₄ were mixed to have the composition of Table 1 in the preparation of the precursor.

### Comparative Example 2

The same process as that in Example 2 was performed except that (NH₄)₂SO₄ was not added when mixing the lithium source.

### Comparative Example 3

The same process as that in Example 2 was performed except that Sr(OH)₂ and (NH₄)₂SO₄ were not added when mixing the lithium source.

### Comparative Example 4

The same process as that in Example 2 was performed except that NiSO₄ and CoSO₄ and MnSO₄ were mixed to have the composition of Table 1 in the preparation of the precursor, and (NH₄)₂SO₄ was not added when mixing the lithium source.

Specifically, a content of each component of the cathode active material was measured by using an inductively coupled plasma (ICP), and the number of moles was converted and shown in Table 1 below.

The cathode active material, Denka Black as a conductive material and PVDF as a binder were mixed in a weight ratio of 92:5:3 to prepare a cathode mixture. The cathode mixture was coated on an aluminum current collector, and then dried and pressed to form a cathode.

### (2) Fabrication of Cathode and Secondary Battery

A graphite-based anode active material and a silicon-based anode active material (SiOx, 0<x<2) were mixed such that a weight ratio of silicon and carbon analyzed with the ICP became 1:99 to prepare an anode active material.

The anode active material, KS6 as a flake-type conductive material and styrene-butadiene rubber (SBR) as a binder were mixed in a weight ratio of 94:0.9:3 to prepare an anode slurry. The anode slurry was coated on a copper substrate, dried and pressed to prepare an anode.

The cathode and the anode prepared as described above were notched by a predetermined size, and the notched cathode and anode were stacked with a separator (polyethylene, thickness: 25 μm) interposed therebetween. Tab portions of the cathode and the anode were welded. The welded cathode/separator/cathode assembly was placed in a pouch, and three sides excluding an electrolyte injection side were sealed. A region around the tab portions was included in the sealing portion. An electrolyte solution was injected through the electrolyte injection side, and then the electrolyte injection side was also sealed, and impregnation was performed for 12 hours or more.

A 1M LiPF₆ solution using a mixed solvent of EC/EMC/DEC (25/45/30; volume ratio) was used as the electrolyte solution. 1 wt % of vinylene carbonate (VC), 0.5 wt % of 1,3-propensultone (PRS), and 0.5 wt % of lithium bis(oxalato)borate (LiBOB) were added to the electrolyte solution.

Thereafter, pre-charging was performed at a current 5A corresponding to 0.25° C. for 36 minutes. After 1 hour, degassing and aging were performed for more than 24 hours, and then formation charging and discharging were performed (charging conditions: 10 CC-CV 0.2C 4.2V 0.05C CUT-OFF, discharging conditions: CC 0.2C 2.5V CUT-OFF). Thereafter, standard charging and discharging were performed at 35° C. (charging conditions: CC-CV 0.5C 4.2V 0.05C CUT-OFF, discharging conditions: CC 0.5C 2.5V CUT-OFF).

TABLE 1

| | Ni, Co, Mn | | | | | | | | | | |
|---|---|---|---|---|---|---|---|---|---|---|---|
| | mole fraction | | | elemental content (ppm) | | | | | | molar ratio | |
| | Ni | Co | Mn | Ni | Co | Mn | Al | Sr | S | Co/Mn | Sr/S |
| Example 1 | 0.90 | 0.05 | 0.05 | 543,793 | 31,583 | 28,382 | — | 438 | 271 | 1.0 | 0.6 |
| Example 2 | 0.91 | 0.05 | 0.04 | 545,003 | 31,152 | 23,850 | 2,631 | 2,366 | 4,100 | 1.2 | 0.2 |
| Example 3 | 0.91 | 0.05 | 0.04 | 558,962 | 30,987 | 24,701 | 4,299 | 429 | 275 | 1.2 | 0.6 |
| Example 4 | 0.91 | 0.05 | 0.04 | 557,395 | 31,080 | 24,591 | 6,405 | 2,066 | 451 | 1.2 | 1.7 |
| Example 5 | 0.92 | 0.05 | 0.03 | 556,525 | 31,028 | 19,417 | 9,583 | 1,232 | 216 | 1.5 | 2.1 |
| Example 6 | 0.94 | 0.03 | 0.03 | 549,000 | 17,600 | 16,400 | 2,230 | 920 | 210 | 1.0 | 1.6 |
| Example 7 | 0.94 | 0.03 | 0.03 | 553,000 | 17,700 | 16,300 | 6,330 | 1,330 | 4,100 | 1.0 | 0.1 |
| Example 8 | 0.98 | 0.01 | 0.01 | 559,764 | 5,356 | 5,458 | 3,716 | 840 | 233 | 0.9 | 1.3 |
| Example 9 | 0.98 | 0.01 | 0.01 | 559,578 | 5,954 | 5,889 | 4,717 | 1,329 | 3,600 | 0.9 | 0.1 |
| Comparative | 0.90 | 0.08 | 0.02 | 598,068 | 53,432 | 14,338 | 3,725 | 435 | 236 | 3.5 | 0.7 |
| Example 1 | | | | | | | | | | | |
| Comparative | 0.90 | 0.05 | 0.05 | 558,962 | 31,807 | 27,001 | 3,721 | 921 | 76 | 1.1 | 4.5 |
| Example 2 | | | | | | | | | | | |
| Comparative | 0.90 | 0.05 | 0.04 | 551120 | 30,326 | 24439 | 3,801 | 0 | 4,200 | 1.2 | — |
| Example 3 | | | | | | | | | | | |
| Comparative | 0.98 | 0.01 | 0.01 | 559,965 | 5,913 | 5,793 | 2,432 | 827 | 63 | 1.0 | 4.8 |
| Example 4 | | | | | | | | | | | |

### Experimental Example

### (1) Measurement of Capacity Retention

5,000 cycles of charging (CC/CV 0.5C 4.3V 0.05C CUT-OFF) and discharging (CC 1.0C 3.0V CUT-OFF) at 45° C. were performed for the lithium secondary batteries according to Examples and Comparative Examples. A discharge capacity retention was evaluated as a percentage of a discharge capacity at the 5,000th cycle relative to a discharge capacity at the 1st cycle.

### (2) Measurement of Gas Generation

As described above, the lithium secondary batteries of Examples and Comparative Examples were repeatedly charged/discharged by 5,000 cycles, and then stored in a chamber at 60° C. After the storage for 16 weeks, the lithium secondary battery was taken out from the chamber and an amount of a gas generation was analyzed using a gas chromatography.

The evaluation results are shown in Table 2 below.

TABLE 2

| | | | capacity retention | gas generation |
|---|---|---|---|---|
| | Co/Mn | Sr/S | (%) | (ml) |
| Example 1 | 1.0 | 0.6 | 94.6 | 48 |
| Example 2 | 1.2 | 0.2 | 96.6 | 24 |
| Example 3 | 1.2 | 0.6 | 94.2 | 57 |
| Example 4 | 1.2 | 1.7 | 96.4 | 29 |
| Example 5 | 1.5 | 2.1 | 94.0 | 50 |
| Example 6 | 1.0 | 1.6 | 91.4 | 67 |
| Example 7 | 1.0 | 0.1 | 89.4 | 64 |
| Example 8 | 0.9 | 1.3 | 81.2 | 115 |
| Example 9 | 0.9 | 0.1 | 79.6 | 108 |
| Comparative | 3.5 | 0.7 | 93.0 | 63 |
| Example 1 | | | | |
| Comparative | 1.1 | 4.5 | 86.4 | 91 |
| Example 2 | | | | |
| Comparative | 1.2 | — | 89.5 | 104 |
| Example 3 | | | | |
| Comparative | 1.0 | 4.8 | 63.4 | 294 |
| Example 4 | | | | |

### (3) DSC Analysis

To evaluate thermal properties of the cathode active materials of Examples 1 and 2 and Comparative Example 1, a heating peak temperature and an exothermic amount were measured using a differential scanning calorimetry (DSC).

The measurement results are shown in Table 3 below.

TABLE 3

| | | | | | | | | | DSC peak | DSC |
|---|---|---|---|---|---|---|---|---|---|---|
| | | | | | | | | | temperature | exothermic |
| | elemental content (ppm) | | | | | | molar ratio | | (onset temp) | amount |
| | Ni | Co | Mn | Al | Sr | S | Co/Mn | Sr/S | (° C.) | (w/g) |
| Example 1 | 543,793 | 31,583 | 28,382 | 2,618 | 438 | 271 | 1.0 | 0.6 | 203 | 1,734 |
| Example 2 | 545,003 | 31,152 | 23,850 | 4,631 | 2,366 | 4,100 | 1.2 | 0.2 | 208 | 1,483 |
| Comparative | 598,068 | 53,432 | 14,338 | 3,725 | 435 | 236 | 3.5 | 0.7 | 193 | 2,345 |
| Example 1 | | | | | | | | | | |

Referring to Table 2, the stable capacity retention was provided even after 5,000 cycles of repeated charging/discharging and the gas generation was suppressed under the high temperature condition in Examples where the Co/Mn ratio was in a range from 0.9 to 1.5 and the Sr/S ratio was 4 or less.

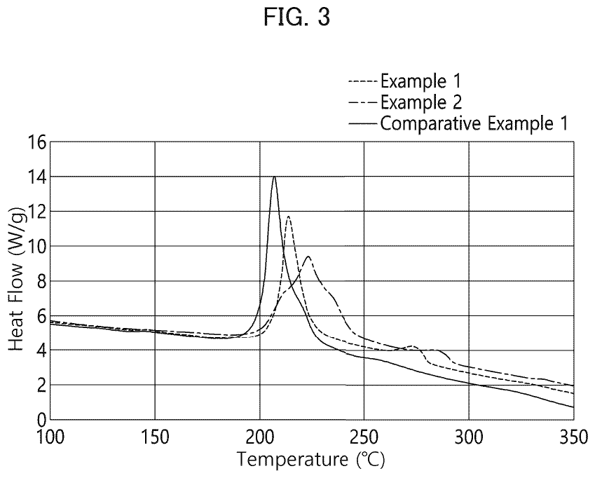

FIG. 3 is a DSC (differential scanning calorimetry) analysis graph of the cathode active material particles of Examples 1 and 2 and Comparative Example 1.

Referring to FIG. 3 and Table 3, in the cathode active materials of Example 1 and Example 2, an exothermic peak was shifted to a higher temperature than that in Comparative Example 1, so that a lower calorific value was obtained. Accordingly, it was predicted that the Co/Mn ratio and the Sr/S ratio were adjusted to also improve the thermal stability.

### (4) Evaluation on Capacity Retention According to Silicon Ratio of Anode Active Material

Secondary batteries were manufactured by the same method as that in Example 1, except that the weight ratio of silicon in the anode active material was increased to 5 wt % (Example 10), 7 wt % (Example 11) and 12 wt % (Example 12).

Thereafter, the capacity retention of each secondary battery according to Examples 10 to 12 was measured by the same method as that in (1).

The measurement results are shown in Table 4 below.

TABLE 4

| | weight ratio in anode | | |
|---|---|---|---|
| | active material (wt %) | | capacity |
| | Si | C | retention (%) |
| Example 1 | 1 | 99 | 94.6 |
| Example 10 | 5 | 95 | 84.9 |
| Example 11 | 7 | 93 | 79.9 |
| Example 12 | 12 | 88 | 57.2 |

As the Si content of the anode active material became increased, the capacity of the secondary battery may be further increased in combination with the above-described cathode active material. However, referring to Example 12, the capacity retention was relatively decreased as the Si content exceeded 10 wt %.

What is claimed is:

1. A cathode active material for a lithium secondary battery comprising a lithium-transition metal oxide including nickel (Ni), cobalt (Co), manganese (Mn), strontium (Sr) and sulfur (S),
wherein a mole fraction of nickel based on the total number of moles of nickel, cobalt and manganese in the lithium-transition metal oxide is 0.9 or more,
a molar ratio of cobalt relative to manganese in the lithium-transition metal oxide is in a range from 0.9 to 1.5, and
a molar ratio of strontium (Sr) relative to sulfur (S) in the lithium-transition metal oxide is greater than 0, and 4 or less.

2. The cathode active material for a lithium secondary battery according to claim 1, wherein the molar ratio of cobalt relative to manganese in the lithium-transition metal oxide is in a range from 1 to 1.5.

3. The cathode active material for a lithium secondary battery according to claim 1, wherein the molar ratio of strontium (Sr) to sulfur (S) in the lithium-transition metal oxide is 0.1 to 3.

4. The cathode active material for a lithium secondary battery according to claim 1, wherein a content of nickel in elements other than lithium and oxygen in the lithium-transition metal oxide is 90 wt % or more.

5. The cathode active material for a lithium secondary battery according to claim 1, wherein the lithium-transition metal oxide further includes Al.

6. The cathode active material for a lithium secondary battery according to claim 5, wherein a content of Al based on a total weight of the lithium-transition metal oxide is in a range from 1,000 ppm to 10,000 ppm.

7. The cathode active material for a lithium secondary battery according to claim 1, the lithium-transition metal oxide comprises a layered structure or a crystal structure represented by Chemical Formula 1:
LiₐSr_{b}(NiₓM1₁₋ₓ)M2_{y}O_{2-z}S_{z} [Chemical Formula 1]
wherein, in Chemical Formula 1, 0.95≤a+b≤1.1, 0<b≤0.1, 0.9≤x<1.0, 0≤y≤0.1, and 0<z≤0.1, and
M1 includes Co and Mn, and M2 includes a heterometal excluding Ni, Co, Mn and Sr.

8. The cathode active material for a lithium secondary battery according to claim 7, wherein, in Chemical Formula 1, M2 includes at least one selected from Al, Rb, Y, Zr, Nb, Mo, Ru, Ag, Sn and Sb.

9. A lithium secondary battery, comprising:
a cathode comprising a cathode active material for a lithium secondary battery according to claim 1; and
an anode facing the cathode and comprising an anode active material that includes a carbon-based active material and a silicon-based active material.

10. The lithium secondary battery according to claim 9, wherein a weight ratio of a silicon element based on a total weight of a carbon element (C) and the silicon element (Si) included in the anode active material is in a range from 1% to 10%.

11. The lithium secondary battery according to claim 9, wherein a weight ratio of a silicon element based on a total weight of a carbon element (C) and the silicon element (Si) included in the anode active material is in a range from 1% to 7%.

12. The lithium secondary battery according to claim 9, wherein the carbon-based active material includes natural graphite or artificial graphite.
